(19) United States
(12) Patent Application Publication
(10) Pub. No.: US 2007/0151851 A1
(43) Pub. Date: Jul. 5, 2007

(54) Gas sensor element

(75) Inventors: Akio Tanaka, Gifu-shi (JP); Nobuyuki Tsuji, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/646,246

(22) Filed: Dec. 28, 2006

(30) Foreign Application Priority Data
Jan. 5, 2006 (JP) 2006-000515
Oct. 25, 2006 (JP) 2006-290092

(51) Int. Cl. G01N 27/26

(52) U.S. Cl. 204/424; 204/431

(57) ABSTRACT

A gas sensor element is disclosed having a solid electrolyte body having oxygen ion conductivity, a measuring gas detecting electrode and a reference gas detecting electrode formed on both surfaces of the solid electrolyte body, respectively, a diffusion resistance layer formed on the one surface of the solid electrolyte body so as to surround the measuring gas detecting electrode and available to permeate measuring gas to the measuring gas detecting electrode, and a catalyst-supported trap layer formed on an outer side surface of the diffusion resistance layer. The catalyst-supported trap layer has an average film thickness of a value ranging from 20 to 200μm, and an amount of the supported catalyst with respect to a gross weight of the catalyst-supported trap layer lies in a value ranging from 0.1 to 2 wt %.

### CROSS REFERENCE TO RELATED APPLICATIONS

This application is based on Japanese Patent Application Nos. 2006-515, filed on Jan. 5, 2006, and 2006-290092, filed on Oct. 25, 2006, the contents of which are hereby incorporated by reference.

### BACKGROUND OF THE INVENTION

1. Field of the invention

The present invention relates to gas sensors for measuring a concentration of specified gas and, more particularly, to a gas sensor element of a gas sensor for use in controlling combustion of an air fuel mixture in an internal combustion engine such as an automotive engine.

2. Description of the Related Art

In modern internal combustion engines, with a view to ensuring global environment conservation, significant studies have been made to apply direct gasoline-injection engines operating with improved fuel consumption engines and internal combustion engines designed for alternative fuel such as CNG (Compressed Natural Gas). With such an increasing movement, there have also been increasing concerns even on a gas sensor for performing combustion control of the internal combustion engine designed for alternative fuel.

However, the internal combustion engine designed for alternative fuel has a tendency with a further increase in the amount of hydrogen gas, contained in exhaust gases especially during a startup of the engine, than that of hydrogen gas contained in exhaust gases of an engine of a gasoline port-injection type. Therefore, the gas sensor encounters an issue with the occurrence of an output deviation due to the presence of hydrogen gas.

Such an issue arises from the occurrence of a difference in flow speed between oxygen gas and hydrogen gas passing across a diffusion resistance layer that limits the amount of measuring gas being introduced. That is, hydrogen gas has a lower molecular weight than oxygen gas and, hence, hydrogen gas reaches a measuring gas detecting electrode at an earlier time than oxygen gas. Thus, oxygen gas contained in measuring gas remains at a lower partial pressure than that of oxygen gas that is actually present. This causes the gas sensor to generate an output deviation.

In particular, an A/F sensor, designed to detect an air fuel ratio through the use of limiting current, has a pronounced tendency of such an output deviation. That is, since the A/F sensor has an elongated diffusion length of a diffusion resistance layer, there is a big difference in transit speed between hydrogen gas and oxygen gas passing through the diffusion resistance layer. This results in an increase in the output deviation.

Further, when no stabilized fuel combustion takes place in the internal combustion engine especially at a startup thereof, exhaust gases emitted from the engine contains hydrogen gas at an increased rate, causing a further significant issue to arise with the occurrence of increased output deviation of the gas sensor.

Furthermore, a three-way catalytic converter, mounted inside an exhaust pipe for purifying exhaust gases, has no adequate purifying capability due to the presence of low temperatures immediately after the engine has started up. Thus, the gas sensor becomes increasingly important to generate a normal output upon activation on an earlier stage.

To achieve such an attempt, Japanese Patent No. 3488818 discloses a gas sensor element 100 that includes a catalyst-supported trap layer 92.

As shown in FIGS. 18A to 20A, the gas sensor element 100 comprises a solid electrolyte body 913, having oxygen ion conductivity, which has one surface carrying thereon a measuring gas detecting electrode 914 and the other surface carrying thereon a reference gas detecting electrode 915 placed in opposition to the measuring gas detecting electrode 914. The gas sensor 100 further comprises a diffusion resistance layer 912, formed on the one surface of the solid electrolyte body 913 so as to surround the measuring gas detecting electrode 914 and available to permeate measuring gas to be detected with the measuring gas detecting electrode 914, and the catalyst-supported trap layer 92 formed on an outer side surface 92a of the diffusion resistance layer 912 and carrying catalyst 922.

With such a structure of the gas sensor element 100, the catalyst-supported trap layer 92 allows catalyst 922 to combust hydrogen gas, thereby suppressing hydrogen gas from reaching the measuring gas detecting electrode 914.

However, with the catalyst-supported trap layer 92, catalyst particles 922 agglutinate with each other under high temperature environments as shown in FIG. 20B, causing deterioration in catalyst ability. Under such a condition, hydrogen gas passes through the diffusion resistance layer 912 at an earlier time than oxygen gas with the resultant occurrence of output deviation.

To address such an issue, it is conceivable to allow the gas sensor element 100 to preliminarily have an increased amount of catalyst particles on consideration of a decrease in catalyst ability resulting from agglutinated catalyst particles 922 as mentioned above.

However, such a structure results in a consequence for the catalyst-supported trap layer 92 to adsorb measuring gas, such as hydrogen gas and oxygen gas, in an excess rate. This causes an increase in time for oxygen gas to arrive at the measuring gas detecting electrode 914, resulting in degraded responsiveness of the gas sensor. Moreover, this causes noble metal particles in the catalyst 922 to come close to each other. Thus, the noble metal particles are liable to agglutinate with each other under high temperature environments, resulting in degradation of catalyst ability.

### SUMMARY OF THE INVENTION

The present has been completed with the above view in mind and has an object to provide a gas sensor element that can prevent deterioration in responsiveness and output deviation while enabling the suppression of endurance deterioration of catalyst ability.

To achieve the above object, one aspect of the present invention provides a gas sensor element comprising a solid electrolyte body having oxygen ion conductivity, and a measuring gas detecting electrode formed on one surface of the solid electrolyte body, a reference gas detecting electrode formed on the other surface of the solid electrolyte body. A diffusion resistance layer is formed on the one surface of the solid electrolyte body so as to surround the measuring gas detecting electrode and available to permeate measuring gas to the measuring gas detecting electrode. A catalyst-supported trap layer, supporting a catalyst, is formed on an outer side surface of the diffusion resistance layer. The catalyst-supported trap layer is composed of a large number of metal oxide particles and catalyst supported on the metal oxide particles and has an average film thickness of a value ranging from 20 to 200 μm, and an amount of the supported catalyst with respect to a gross weight of the catalyst-supported trap layer lies in a value ranging from 0.1 to 2 wt %.

The gas sensor element of the present embodiment has the catalyst-supported trap layer carrying thereon the catalysts. This allows the catalyst-supported trap layer to adequately combust hydrogen gas contained in measuring gas, enabling a reduction in the amount of hydrogen that would arrive at the measuring gas detecting electrode. This results in capability of preventing an output deviation of a gas sensor resulting from the presence of hydrogen gas.

Further, the catalyst-supported trap layer has the average film thickness of a value ranging from 20 to 200 μm and the amount of the supported catalyst lies in a value ranging from 0.1 to 2 wt %. That is, the catalyst-supported trap layer has the adequately large average film thickness and the supported catalysts are set to an adequately lowered concentration. This enables the provision of a gas sensor element that can preclude deterioration in responsiveness of the gas sensor element and output deviation thereof while enabling the suppression of endurance deterioration of the catalysts.

That is, with the structure of the gas sensor element mentioned above, the noble metal particles of the catalysts are prevented from getting extremely closer to each other. Therefore, even if the gas sensor is operating under high temperature environments, no aggregation of the noble metal particles takes place. This prevents the occurrence of endurance deterioration of catalyst ability after the use of the gas sensor and even after the endurance of the gas sensor, the catalysts can adequately combust hydrogen gas.

Furthermore, since the amount of supported catalyst is as low as 0.1 to 2 wt %, measuring gas is prevented from being excessively adsorbed in the catalyst-supported trap layer. This prevents an increase in time for oxygen gas to arrive at the measuring gas detecting electrode, making it possible to prevent deterioration in responsiveness of the gas sensor.

In addition, since the catalyst-supported trap layer has the average film thickness less than 200 μm, no catalyst-supported trap layer is peeled off from the outer side surface of the catalyst-supported trap layer. Moreover, no need arises for an excessive amount of catalysts to be supported in the catalyst-supported trap layer, the gas sensor element can be manufactured at low cost.

As set forth above, according to the present invention, a gas sensor element can be provided which can prevent deterioration in responsiveness and output deviation, while suppressing endurance deterioration of catalyst ability.

With the gas sensor element of the present embodiment, the metal oxide particles may be composed of alumina particles having a γ- or θ-crystal structure.

With such a structure, since the catalyst-supported trap layer can be structured with alumina particles having adequately increased surface areas, the catalysts can be uniformly dispersed on the surfaces of the metal oxide particles without causing aggregation of the same.

With the gas sensor element of the present embodiment, the metal oxide particles may have an average particle diameter of a value ranging from 1 to 50 μm, and the catalyst-supported trap layer has a porosity of a value ranging from 40 to 70% with an average pore size diameter of a value ranging from 0.1 to 10 μm.

With such a structure, the metal oxide particles have adequately increased surface areas for the catalysts to be supported and the catalyst-supported trap layer enables to permeate measuring gas at an adequate flow rate. Moreover, the catalyst-supported trap layer can reliably prevent harmful substances (such as, for instance, Pb, P and S or the like), toxic to electrode materials of the measuring gas detecting electrode and the reference gas detecting electrode, from arriving to the measuring gas detecting electrode and reference gas detecting electrode.

Meanwhile, in a case where the metal oxide particles have the particle diameter less than 1 μm, in a case where the catalyst-supported trap layer has the porosity less than 40% or in a case where the average pore size diameter is less than 0.1 μm, a risk occurs for measuring gas to be introduced at inadequate flow rate. Moreover, in a case where the metal oxide particles have the particle diameter exceeding 50 μm, in a case where the catalyst-supported trap layer has the porosity greater than 70% or in a case where the metal oxide particles have the average pore size diameter greater than 10 μm, it becomes hard to preclude toxic substances from arriving at the measuring gas detecting electrode and the reference gas detecting electrode.

With the gas sensor element of the present embodiment, the catalyst-supported trap layer may be formed on the outer side surface of the diffusion resistance layer and extend in an area located at a position distanced from the outer side surface by a value ranging from 20 to 200 μm.

Such a structure enables measuring gas to reliably pass through the catalyst-supported trap layer in an adequate length, thereby adequately preventing hydrogen gas, contained in measuring gas, from arriving to the measuring gas detecting electrode. In addition, this results in a decrease in production cost of the gas sensor element.

Meanwhile, if the catalyst-supported trap layer does not extend to the area distanced from the outer side surface of the catalyst-supported trap layer by 20 μm, a risk takes place for a portion of measuring gas to arrive at the measuring gas detecting electrode without passing through the catalyst-supported trap layer in an adequate length.

Further, in a case where the catalyst-supported trap layer extends to an area exceeding 200 μm distanced from the outer side surface of the catalyst-supported trap layer, a probability occurs for production cost of the gas sensor element to increase.

With the gas sensor element of the present embodiment, the catalyst may include noble metal particles having an average particle diameter of a value ranging from 0.05 to 0.5 μm.

Such a structure enables the prevention of deterioration in activity of the catalyst-supported trap layer, while preventing the noble metal particles in the catalyst from agglutinating with each other even under high temperature environments.

Meanwhile, in a case where the noble metal particles have the average particle diameter less than 0.05 μm, the noble metal particles are liable to move in the catalyst with the resultant increased probability for the noble metal particles to agglutinate with each other under the high temperature environments.

Moreover, in a case where the noble metal particles have the average particle diameter greater than 0.5 μm, the noble metal particles have lessened total surface areas, causing an increased risk to occur for the catalyst-supported trap layer to have reduced activity.

With the gas sensor element of the present embodiment, the amount of the supported catalyst particles per unit surface area of the metal oxide particles forming the catalyst-supported trap layer lies in a value ranging from 7×10⁻⁶ to 2.9×10⁻⁴ g/m².

Such a structure allows the present invention to adequately offer various advantageous effects.

On the contrary, in a case where the amount of supported catalyst is greater than 2.9×10⁻⁴ g/m², the noble metal particles in the catalyst are too close in distance with the resultant increased probability for the noble metal particles to easily aggregate.

A second aspect of the present invention provides a gas sensor element comprising a solid electrolyte body having oxygen ion conductivity, a measuring gas detecting electrode formed on one surface of the solid electrolyte body, and a reference gas detecting electrode formed on the other surface of the solid electrolyte body. A diffusion resistance layer is formed on the one surface of the solid electrolyte body so as to surround the measuring gas detecting electrode and available to permeate measuring gas to the measuring gas detecting electrode. A catalyst-supported trap layer, supporting a catalyst, is formed on an outer side surface of the diffusion resistance layer. The catalyst-supported trap layer is composed of a large number of metal oxide particles and catalyst supported on the metal oxide particles in a dispersion degree ranging from 0.005 to 0.1 pieces/μm².

The gas sensor element of the present embodiment includes the catalyst-supported trap layer in which the catalysts are supported. With such a structure, the catalyst-supported trap layer can adequately combust hydrogen gas, thereby achieving a remarkable reduction in the amount of hydrogen gas arriving at the measuring gas detecting electrode while making it possible to minimize an output deviation of the gas sensor for preventing the output deviation.

Further, the catalyst-supported trap layer contains the catalysts having the dispersion degree ranging from 0.005 to 0.1 piece/μm². This enables the production, of a gas sensor element wherein the catalyst-supported trap layer is formed in a structure to adequately decrease a value of the dispersion degree representing a physical volume of the catalyst per unit surface area of the catalyst-supported trap layer while providing capability of preventing deterioration in responsiveness and the output deviation.

That is, with such a structure set forth above, none of the noble metal particles of the catalyst get extremely closer to each other under high temperature environments during operation of the gas sensor installed on the engine. Thus, no aggregation of the noble metal particles takes place even under such high temperature environments. This enables the suppression of endurance degradation of catalyst ability after the use of the gas sensor and, even after the duration of the gas sensor, the catalyst can combust hydrogen gas in a reliable manner.

Further, since the catalyst has an adequately low dispersion degree, measuring gas can be prevented from being adsorbed to the catalyst-supported trap layer in excess. This also prevents an increase in time for measuring gas to arrive at the measuring gas detecting electrode. As a result, the gas sensor has no deteriorated responsiveness. Moreover, no need arises for an excess amount of catalysts to be supported on the metal oxide particles, achieving a reduction in production cost of the gas sensor element.

As set forth above, according to the present invention, a gas sensor element can be provided which can prevent deterioration in responsiveness and output deviation while suppressing endurance degradation of catalyst ability.

A third aspect of the present invention provides a gas sensor element comprising a solid electrolyte body having oxygen ion conductivity, and a measuring gas detecting electrode formed on one surface of the solid electrolyte body, a reference gas detecting electrode formed on the other surface of the solid electrolyte body. A diffusion resistance layer is formed so as to surround the measuring gas detecting electrode and available to permeate measuring gas to the measuring gas detecting electrode. A catalyst layer is formed on an outer side surface of the diffusion resistance layer and including a large number of aid materials and large number of catalysts which are mixed with each other. The catalysts include noble metal particles having an average particle diameter of a value ranging from 0.5 to 5 μm.

The gas sensor element includes the catalyst layer composed of the aid materials and the catalysts in a mixed state. Therefore, the catalyst layer can combust hydrogen gas in a reliable manner. This adequately enables a reduction in the amount of hydrogen gas that would arrive at the measuring gas detecting electrode.

This results in the prevention of output deviation of a gas sensor due to the presence of hydrogen gas.

Further, the catalysts include noble metal particles having an average particle diameter of a value ranging from 0.5 to 5 μm. That is, the noble metal particles have a relatively large average particle diameter. This enables the provision of a gas sensor element that can prevent degradation of responsiveness and output deviation while enabling the suppression of endurance degradation of catalyst ability.

That is, under circumstances where a gas sensor is exposed to high temperature environments when, for instance, a vehicle is running at a high speed, an internal combustion engine installed on the vehicle is operated under feedback control so as to supply a combustion chamber with a rich air fuel mixture with a view to achieving improved fuel consumption. When this takes place, if the gas sensor element of the gas sensor installed on the engine has catalysts including noble metal particles having a small average particle diameter, the noble metal particles are liable to evaporate or agglutinate with the resultant increase in risk of the occurrence of a drop in catalyst ability.

In contrast, since the gas sensor element of the present invention employs the catalyst including the noble metal particles which has a relatively large average particle diameter in a range from 0.5 to 5 μm, no evaporation or agglutination of the noble metal particles take place even under severe usage environments such as high temperature atmosphere set forth above. This results in capability of preventing deterioration in catalyst ability while precluding the occurrence of deterioration in responsiveness and output deviation and suppressing endurance degradation of catalyst ability.

As set forth above, according to the present invention, a gas sensor element can be provided which can prevent deterioration in responsiveness and output deviation while suppressing endurance degradation of catalyst ability.

### BRIEF DESCRIPTION OF THE DRAWINGS

FIG. 1 is an illustrative view showing a gas sensor element of a first embodiment according to the present invention with a diffusion resistance layer and a catalyst-supported trap layer formed on an outer side surface of the diffusion resistance layer being illustrated in an enlarged scale.

FIG. 2 is an illustrative view showing component parts of the catalyst-supported trap layer.

FIG. 3 is a cross sectional view showing the gas sensor element of the first embodiment according to the present invention incorporating the structure shown in FIG. 1.

FIG. 4 is an illustrative view showing how measuring gas travels through the catalyst-supported trap layer and the diffusion resistance layer.

FIG. 5 is a cross sectional view showing a gas sensor element of a second embodiment according to the present invention.

FIG. 6 is a cross sectional view showing a cup-shaped gas sensor element of a third embodiment according to the present invention.

FIG. 7 is a cross sectional view showing a gas sensor element of a fourth embodiment according to the present invention.

FIG. 8 is a cross sectional view showing a gas sensor element of a fifth embodiment according to the present invention.

FIG. 9 is a graph showing the relationship between an early stoichiometric deviation and an average film thickness of a catalyst-supported trap layer.

FIG. 10 is a graph showing the relationship between a response time of a gas sensor, an average film thickness of a catalyst-supported trap layer and the amount of supported catalyst.

FIG. 11 is a graph showing the relationship between stoichiometric deviation after endurance of a gas sensor, an average film thickness of a catalyst-supported trap layer and the amount of supported catalyst.

FIG. 12 is a graph showing the relationship between an early stoichiometric deviation of a gas sensor, an average film thickness of a catalyst-supported trap layer, and a response time of the gas sensor and the amount of supported catalyst.

FIG. 13 is a cross sectional view of a gas sensor of a sixth embodiment according to the present invention showing a catalyst-supported trap layer formed on an outer side surface of a diffusion resistance layer.

FIG. 14 is a graph showing the relationship between a particle diameter of noble metal particles of a catalyst and a particle diameter change rate.

FIG. 15 is a graph showing the relationship between a particle diameter of noble metal particles of a catalyst and an early stoichiometric deviation of a gas sensor.

FIG. 16 is a graph showing the relationship between a particle diameter of noble metal particles of a catalyst and an early stoichiometric deviation of a gas sensor before endurance thereof.

FIG. 17 is a graph showing measured results on a deviation level of a value k before and after endurance of the gas sensor element with various alterations being made on attribute of a catalyst layer.

FIGS. 18A and 18B are cross sectional views showing a gas sensor element of the related art.

FIG. 19 is an illustrative view showing a structure in which a catalyst-supported trap layer is formed on an outer side surface of a diffusion resistance layer.

FIG. 20A is an illustrative view showing component elements of the catalyst-supported trap layer of the gas sensor element shown in FIG. 19 before the endurance.

FIG. 20B is an illustrative view showing component elements of the catalyst-supported trap layer of the gas sensor element shown in FIG. 19 after the endurance.

### DETAILED DESCRIPTION OF THE PREFERRED EMBODIMENTS

Now, gas sensor elements of various embodiments according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views. Also in the following description, description on the same component parts of one embodiment as those of another embodiment is omitted, but it will be appreciated that like reference numerals designate the same component parts throughout the drawings.

### Embodiment

Before entering into detailed description of gas sensor elements of various embodiments according to the present invention, description is made of general features of the gas sensor elements.

That is, the gas sensor elements of the various embodiments include gas sensor elements that can be applied to an A/F sensor, a NOx sensor and an oxygen sensor. Among these, the present invention may be preferably applied to the A/F sensor.

With the first aspect of the present invention mentioned above, if the catalyst-supported trap layer has an average film thickness in a value less than 20 μm, the catalysts are probable to get extremely closer to each other. This causes the noble metal particles to agglutinate under usage in high temperature environments.

In contrast, if the catalyst-supported trap layer has the average film thickness in a value greater than 200 μm, the catalyst-supported trap layer is liable to be peeled off from the outer side surface of the diffusion resistance layer. Also, this results in an increase in production cost.

Therefore, the average film thickness of the catalyst-supported trap layer may be preferably selected to line in a range from 60 to 200 μm.

With the gas sensor element of the second aspect of the present invention mentioned above, further, if the dispersion degree of the catalysts is less than 0.005 pieces/μm², hydrogen gas is hard to be adequately combusted.

On the contrary, if the dispersion degree of the catalysts exceeds 0.1 pieces/μm², the noble metal particles get extremely closer to each other, thereby causing the noble metal particles to agglutinate under usage in high temperature environments.

Further, the dispersion degree of the catalyst can be analyzed upon, for instance, image processing a SEM image on a cross section of the catalyst-supported trap layer and measuring the number of the catalysts per unit surface area.

With the gas sensor element of the third aspect of the present invention mentioned above, furthermore, if the noble metal particles of the catalysts have the average particle diameter less than 0.5 μm, the noble metal particles are liable to evaporate or agglutinate under severe usage environments when the gas sensor is operating at high temperature environments. As a result, it becomes hard to prevent endurance degradation of catalyst ability.

Meanwhile, if the noble metal particles of the catalysts have the average particle diameter greater than 5 μm, the noble metal particles have reduced total surface areas. This results in a drop in catalyst ability with the resultant difficulty of preventing degradation of responsiveness and output deviation.

Moreover, with the gas sensor element of the present embodiment, the metal oxide particles may be composed of alumina particles having a γ-or θ-crystal structure.

With such a structure, the catalyst-supported trap layer is composed of the alumina particles with increased surface areas. This enables a desired amount of catalysts to be supported on the surfaces of the metal oxide particles in a uniformly dispersed pattern.

With the gas sensor element of the present embodiment, the metal oxide particles may have an average particle diameter of a value ranging from 1 to 50 μm, and the catalyst-supported trap layer may have a porosity of a value ranging from 40 to 70% with an average pore size diameter of a value ranging from 0.1 to 10 μm.

With such a structure, the metal oxide particles have adequate surface areas needed for carrying thereon the catalysts and the catalyst-supported trap layer enables measuring gas to permeate at an adequate flow rate. In addition, the catalyst-supported trap layer has a function to prevent harmful substances (including toxic compounds such as, for instance, Pb, P, S or the like), toxic to electrode materials of the measuring gas detecting electrode and the reference gas detecting electrode, from arriving to the measuring gas detecting electrode and the reference gas detecting electrode.

Meanwhile, in a case where the metal oxide particles have the average particle diameter less than 1 μm, in a case where the catalyst-supported trap layer have the porosity less than 40% or in a case where the average pore size diameter is less than 0.1 m, the amount of measuring gas being introduced becomes insufficient for accurate detection.

Further, in a case where the metal oxide particles have the average particle diameter greater than 50 μm, in a case where the catalyst-supported trap layer have the porosity greater than 70% or in a case where the average pore size diameter is greater than 10 μm, the catalyst-supported trap layer encounters a difficulty of preventing harmful substances from arriving at the measuring gas detecting electrode and the reference gas detecting electrode.

With the gas sensor element of the present embodiment, the catalyst-supported trap layer may be formed on the outer side surface of the diffusion resistance layer and extends in an area located at a position distanced from the outer side surface by a value ranging from 20 to 200 μm.

With such a structure, measuring gas can travel through the catalyst-supported trap layer in an adequate length in a reliable manner. This enables hydrogen gas in measuring gas to be prevented from arriving at the measuring gas detecting electrode. In addition, this prevents an increase in production cost.

Meanwhile, in a case where the catalyst-supported trap layer does not extend to the position distanced from the outer side surface by a value of 20 μm, a risks occurs wherein a portion of measuring gas does not pass through the catalyst-supported trap layer in the adequate length and comes to the measuring gas detecting electrode.

Further, in another case where the catalyst-supported trap layer is formed in an area exceeding a value of 200 μm from the outer side surface of the trap layer, there is a risk with the occurrence of an increase in production cost of the gas sensor element.

With the gas sensor element of the present embodiment, further, the catalyst may include noble metal particles having an average particle diameter of a value ranging from 0.05 to 0.5 μm.

With such a structure, no deterioration takes place in activity of the catalyst-supported trap layer, while adequately preventing the noble metal particles of the catalyst from agglutinating with each other even in usage under high temperature environments.

Meanwhile, in a case where the noble metal particles have the average particle diameter less than 0.05 μm, the noble metal particles of the catalyst are liable to easily move, causing the noble metal particles to easily agglutinate under high temperature environments.

In addition, if the noble metal particles have the average particle diameter greater than 0.5 μm, the noble metal particles have a reduced total surface area, causing a drop in activity of the catalyst-supported trap layer.

With the gas sensor element of the present embodiment, an amount of the supported catalyst particles per unit surface area of the metal oxide particles forming the catalyst-supported trap layer may lie in a value ranging from 7×10⁻⁶ to 2.9×10⁻⁴ g/m².

In such a case, the gas sensor element can adequately provide advantageous effects of the present invention.

Meanwhile, if the amount of the supported catalyst particles per unit surface area of the metal oxide particles is less than a value of 7×10⁻⁶ g/m², the amount of supported catalysts is too small, causing a difficulty to occur in adequately combusting hydrogen gas.

Moreover, if the amount of the supported catalyst particles per unit surface area of the metal oxide particles is greater than a value of 2.9×10⁻⁴ g/m², the noble metal particles of the catalyst get closer to each other in distance and are caused to agglutinate.

With the gas sensor element of the present embodiment, the catalyst layer may have an average film thickness of a value ranging from 5 to 50 μm.

In such a case, a catalyst layer can be formed in a uniform thickness, thereby adequately preventing degradation of responsiveness of a gas sensor and output deviation thereof. In addition, the formation of such a catalyst layer can prevent a positional displacement or a peeling phenomenon of the catalyst layer.

Meanwhile, if the average film thickness is less than 5 μm, the catalyst layer becomes hard to be formed in a uniform thickness due to the influence of a surface roughness arising on the diffusion resistance layer serving as a base of the catalyst layer. In such a case, measuring gas passes through the catalyst layer in an area with a thin film thickness, resulting in an increase in output deviation.

On the contrary, if the average film thickness is greater than 50 μm, the catalyst film is formed in increased manufacturing steps (including the number of steps of printing paste) until a desired film thickness is obtained. This results in increased risks with the occurrence of defects such as a dislocated placement position of the catalyst layer and the peeling of the catalyst layer. In addition, with the catalyst layer formed in such a large film thickness, deterioration takes place in responsiveness of a gas sensor.

With the gas sensor element of the present embodiment, the catalyst layer may include the catalysts whose noble metal particles have 10 to 80 wt % gross weight with respect to a gross weight of the catalyst layer.

Such a structure allows the catalyst layer to have adequate catalyst ability, thereby preventing degradation of responsiveness and output deviation of a gas sensor in a reliable manner. In addition, deficiencies such as cracking or peeling-off of the catalyst layer can be avoided in a highly reliable manner.

Meanwhile, if a percentage of the gross weight of the catalysts is less than 10 wt %, the catalyst layer has inadequate catalyst ability. This causes hydrogen gas in measuring gas to be hardly combusted, causing output deviation to occur. That is, with the gas sensor element of the third aspect of the present invention, the catalyst has the relatively large average particle diameter ranging from 0.5 to 5 μm, the catalyst has a decreased specific surface area. If the percentage of the gross weight of the catalyst is less than 10 wt % in addition to the presence of such a decreased specific surface area, a total surface area of the noble metal particles forming the catalyst decreases, resulting in a reduction in surface areas of the noble metal particles of the catalyst for hydrogen gas to be combusted.

Further, as the gas sensor element is repeatedly subjected to thermal shock cycles under circumstances where the percentage of the gross weight of the catalyst is greater than 80 wt %, a risk occurs with the occurrence of cracking or peeling-off between the catalyst layer and the diffusion resistance layer due to a difference in heat expansion coefficient between the diffusion resistance layer and the aid materials. Further, another risk includes deterioration of catalyst ability and degraded responsiveness of the gas sensor element.

With the gas sensor element of the present embodiment, the catalyst layer may have a porosity of a value ranging from 15 to 50%.

Such a structure enables the prevention of degradation of responsiveness and output deviation of the gas sensor element. Further, deficiencies such as cracking or peeling-off of the catalyst layer can be avoided in a reliable manner.

Meanwhile, if the porosity of the catalyst layer is less than 15%, measuring gas cannot be adequately dispersed in the catalyst layer, causing a risk to occur with deterioration of responsiveness.

In addition, if the porosity of the catalyst layer is greater than 50%, the catalyst layer is adhered to the diffusion resistance layer with a decreased bonding force with the resultant drop in strength of the catalyst layer, causing a risk to occur with deficiencies such as cracking or peeling-off of the catalyst layer. In addition, measuring gas is dispersed in the catalyst layer in a diffused state in excess and catalyst ability cannot follow the dispersion of measuring gas. This results in the occurrence of output deviation.

With the gas sensor element of the present embodiment, the aid materials may be composed of more than one kind of material selected from the group consisting of at least alumina, zirconium and glass.

The presence of the aid materials enables the difference in heat expansion coefficient between the base, such as the diffusion resistance layer, of the catalyst layer and the catalyst layer to be adequately minimized. Therefore, even when the gas sensor is frequently exposed to the thermal shock cycles, no cracking or peeling-off of the catalyst layer take place in usage under high temperature environments.

Also, glass may include borosilicate glass or the like.

With the gas sensor element of the present embodiment, the catalyst layer may be formed by printing a paste for the catalyst layer on the outer side surface of the diffusion resistance layer with the paste being subjected to heat treatment at temperatures higher than 900° C.

In such a case, the catalyst layer can be formed in an easy and reliable manner. This prevents degradation of catalyst ability, while enabling improvements on durability of the catalyst and output deviation of the gas sensor.

With the gas sensor element of the present embodiment, the catalysts may be composed of more than one kind of material selected from the group consisting of at least Pt, Rh and Pd.

In such a case, a gas sensor element can be provided including the catalyst that can adequately exhibit advantageous effects of the present invention.

With the gas sensor element of the present embodiment, the diffusion resistance layer may comprise more than one kind of porous material selected from the group consisting of at least alumina and zirconium, and a diffusion distance, representing a length in which a linear line, interconnecting the outer side surface of the diffusion resistance layer and the measuring gas detecting electrode, passes through the diffusion resistance layer, lies in a value greater than 0.2 mm.

Such a structure can adequately exhibit advantageous effects of the present invention.

That is, in a case where the diffusion distance is greater than 0.2 mm, there occurs a big difference in time needed for oxygen gas to arrive at the measuring gas detecting electrode and time needed for hydrogen gas to arrive at the measuring gas detecting electrode in the absence of the catalyst-supported trap layer or the catalyst layer of the present invention. This causes a gas sensor to generate output deviation. Accordingly, applying the structures of the first to third aspects of the present invention to the gas sensor element, having the diffusion distance in the range exceeding 0.2 mm, provides advantageous effects of the present invention.

Meanwhile, if the diffusion distance is less than 0.2 mm, the diffusion distance is relatively small and, thus, there occurs a small difference in time needed for oxygen gas to arrive at the measuring gas detecting electrode and time needed for hydrogen gas to arrive at the measuring gas detecting electrode. Therefore, no issue arises for output deviation to be provided with the gas sensor implementing the present invention.

With the gas sensor element of the present embodiment, an activity time is selected to lie in a value less than five seconds.

In this case, the gas sensor element of the present embodiment can provide a normal sensor output at an earlier time, immediately after the engine has started up, at which correctly measuring a concentration of specified gas in measuring gas becomes a serious concern.

Further, in order to allow a gas sensor to have activity on an early stage, the gas sensor needs to have the gas sensor element with minimized heat capacity while having a minimized structure in size. In such a case, when the gas sensor element is exposed to exhaust gases prevailing at high temperatures, the catalyst-supported trap layer or the catalyst layer are liable to suffer heat damage in a further increased extent. In the light of such severe condition, the gas sensor element selected to have the activity time less than five seconds provides an improvement over heat resistance property.

Meanwhile, if the activity time exceeds five seconds, it becomes hard to obtain normal sensor output on an earlier stage immediately after startup of the engine.

### First Embodiment

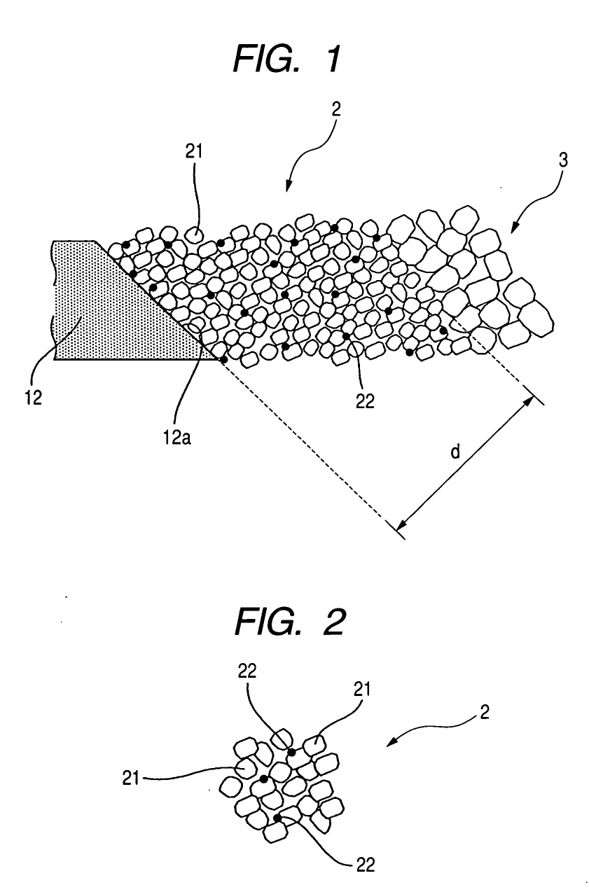

Now, a gas sensor element of a first embodiment according to the present invention is described below in detail with reference to FIGS. 1 to 3.

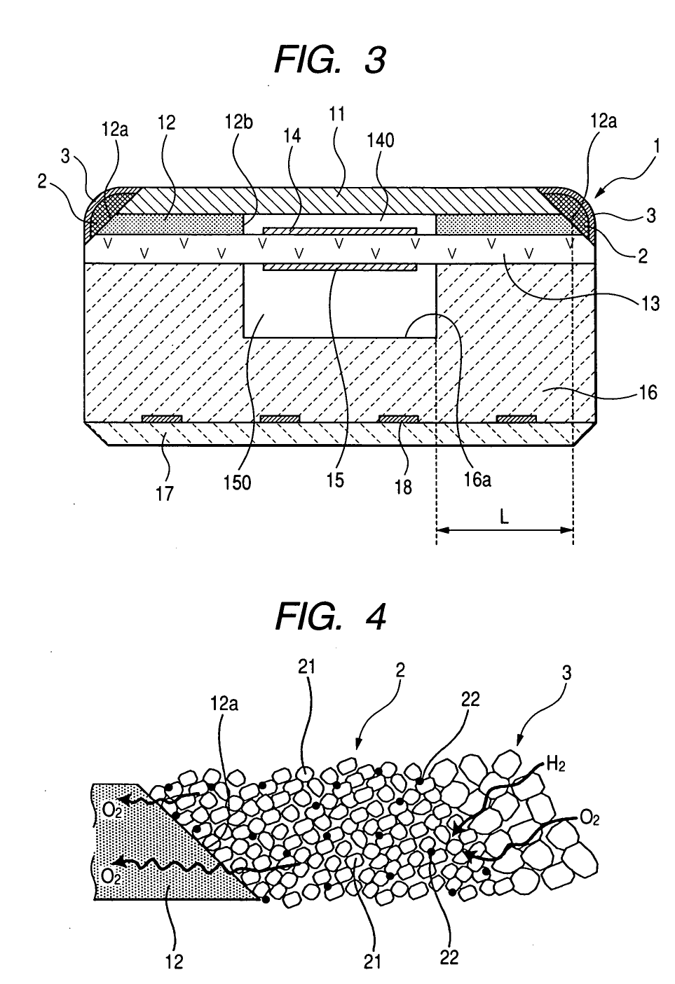

As shown in FIGS. 1 and 3, the gas sensor 1 of the present embodiment comprises a solid electrolyte body 13, having oxygen ion conductivity, which has one surface carrying thereon a measuring gas detecting electrode 14 and the other surface carrying thereon a reference gas detecting electrode 15 placed in opposition to the measuring gas detecting electrode 14. The gas sensor 1 further comprises a diffusion resistance layer 12, formed on the one surface of the solid electrolyte body 13 so as to surround the measuring gas detecting electrode 14 and available to permeate targeted measuring gas to be detected with the measuring gas detecting electrode 14, and a catalyst-supported trap layer 2 formed on an outer side surface 12a of the diffusion resistance layer 12 and carrying catalyst 22.

As shown in FIGS. 1 and 2, the catalyst-supported trap layer 2 is made of a large number of metal oxide particles 21 and catalyst particles supported on the metal 25 oxide particles 21 in a uniform pattern. The catalyst-supported trap layer 2 has a thickness of a value ranging from 20 to 200 μm and the amount of catalyst particles 22, supported in the catalyst-supported trap layer 2, is set to lie in a value ranging from 0.1 to 2 wt % with respect to a gross weight of the catalyst-supported trap layer 2.

Further, the catalyst particles are dispersed in the catalyst-supported trap layer 2 at a dispersion degree in a range from 0.005 to 0.1 pieces/μm². Here, the term “dispersion degree” refers to the number of catalyst particles, dispersed in the catalyst-supported trap layer 2, which is obtained upon image processing an SEM image (a reflected electron image with 5000-fold in the present embodiment) and counting the number of catalyst particles 22 per unit surface area.

Next, the gas sensor element 1 of the present embodiment is described below in detail.

With the present embodiment, the gas sensor element 1 is incorporated in an A/F sensor.

Further, with the gas sensor element 1, the solid electrolyte body 13 is made of zirconium providing oxygen ion conductivity and the measuring gas detecting electrode 14, made of platinum, which is formed on the one surface of the solid electrolyte body 13 as shown in FIG. 3.

In addition, the reference gas detecting electrode 15, made of platinum, is formed on the other surface of the solid electrolyte body 13 in an area in opposition to the measuring gas detecting electrode 14 as shown in FIG. 3.

A reference gas chamber forming layer 16, made of alumina ceramic, is stacked on the other surface of the solid electrolyte body 13. The reference gas chamber forming layer 16 has electrical insulation property and is dense in a structure not to permeate gas therethrough. In addition, the reference gas chamber forming layer 16 is formed with a recessed section 16a, acting as a reference gas chamber 150, to which atmospheric air is introduced as reference gas.

Moreover, a heater substrate 17 is stacked on the reference gas chamber forming layer 16 on a bottom surface thereof.

The heater substrate 17 has one surface carrying thereon a plurality of electrical heating elements 18, placed in the one surface at horizontally spaced positions so as to face the reference gas chamber forming layer 16, which are electrically conductive and energized to develop heat. The heating elements 18 are warmed to allow the gas sensor element 1 to reach an active temperature.

Further, a shielding layer 11, made of alumina and having a dense structure not to permeate gas, is stacked on the diffusion resistance layer 12 so as to face the measuring gas detecting electrode 14 formed on the solid electrolyte body 13. The diffusion resistance layer 12 is sandwiched between the shielding layer 11 and the solid electrolyte body 13 and formed with an opening portion 12b in which the measuring gas detecting electrode 14 is accommodated. The opening portion 12b of the diffusion resistance layer 12 defines a measuring gas chamber 140 under a status covered with the shielding layer 11, the opening portion 12b of the diffusion resistance layer 12 and the solid electrolyte body 13 for measuring gas to be detected with the measuring gas detecting electrode 14.

Furthermore, as set forth above, the outer side surfaces 12a of the diffusion resistance layer 12 carry thereon the catalyst-supported trap layer 2 supporting therein the catalyst particles 22 as shown in FIGS. 1 and 3.

The metal oxide particles 21 of the catalyst-supported trap layer 2 are composed of alumina particles having a γ- or θ-crystal structure.

Moreover, the metal oxide particles 21 have an average particle diameter of a value ranging from 1 to 50 μm and the catalyst-supported trap layer 2 has a porosity of a value ranging from 40 to 70% with an average pore size diameter of a value ranging from 0.1 to 10 μm.

As shown in FIG. 3, the catalyst-supported trap layer 2 is formed not only on the outer side surface 12a but also in an area located at a position distanced from the outer side surface 12a by a value ranging from 20 to 200 μm.

In addition, the amount of the supported catalyst particles 22 per unit surface area of the metal oxide particles 22 forming the catalyst-supported trap layer 2 lies in a value ranging from 7×10⁻⁶ to 2.9×10⁻⁴ g/m².

Moreover, the catalyst particles 22 have noble metal particles with an average particle diameter falling in a value ranging from 0.05 to 0.5 μm.

As shown in FIG. 3, further, a linear line “L”, interconnecting the outer side surface 12a of the diffusion resistance layer 12 and the measuring gas detecting electrode 14 and representing a length extending through the diffusion resistance layer 12, lies in a value equal to or greater than 0.2 mm. With the gas sensor element 1 of the present embodiment, the diffusion distance L represents a distance from the outer side surface 12a to the opening portion 12b of the diffusion resistance layer 12.

In addition, the gas sensor element 1 of the present embodiment is structured to have an activity time less than 5 seconds.

Further, the catalyst-supported trap layer 2 is covered with a protective trap layer 3 that is made of alumina particles and formed in a rounded shape in cross section as viewed in FIG. 3. In addition, the alumina particles, forming the protective trap layer 3, have particle diameters falling in a value ranging from 10 to 50 μm. Meanwhile, the protective trap layer 3 has a porosity rate of a value ranging from 40 to 70% with an average pore size diameter falling in a value ranging from 1 to 10 μm. Moreover, although the protective trap layer 3 has no catalyst particles, the protective trap layer 3 may carry the catalyst particles if a need arises for the catalyst particles of the catalyst-supported trap layer 2 to have further increased durability and stability.

The use of the catalyst-supported trap layer 2 and the protective trap layer 3 result in capability of preventing the diffusion resistance layer 12 and the measuring gas detecting electrode 14 from being contaminated with toxic substances such as P, Ca, Pb or the like with the resultant occurrence of degradation.

Further, covering the catalyst-supported trap layer 2 with the protective trap layer 3 enables noble metal components of the catalyst particles 22 from being scattered.

Now, description is made of how oxygen gas travels in the gas sensor element 1 of the present embodiment to reach the measuring gas detecting electrode 14. Also, hereunder, the gas sensor element 1 of the present embodiment is described below in detail with reference to hydrogen gas (H₂) and oxygen gas (O₂).

As shown in FIG. 4, measuring gas contains hydrogen gas H₂ and oxygen gas O₂ that permeate through the protective trap layer 3 into the catalyst-supported trap layer 2.

Since the catalyst-supported trap layer 2 carries therein the catalyst particles 22 composed of Pt and Rh, a reaction takes place between hydrogen gas H₂ and oxygen gas O₂ in the presence of the catalyst particles 22, creating water. Therefore, hydrogen gas mostly combusts in the catalyst-supported trap layer 2, thereby preventing a large amount of hydrogen from being introduced to the measuring gas chamber 140.

Then, oxygen gas, passing across the catalyst-supported trap layer 2, travels through the diffusion resistance layer 12 and arrives at the measuring gas detecting electrode 14.

Now, the operation of the gas sensor element 1 is described below in detail with reference to FIGS. 1 to 4.

As shown in FIGS. 1 to 4, the gas sensor element 1 of the present embodiment includes the catalyst-supported trap layer 2 in which the catalyst particles 22 are supported. This enables the catalyst-supported trap layer 2 to adequately combust hydrogen gas contained in measuring gas, remarkably decreasing the amount of hydrogen gas coming to the measuring gas detecting electrode 14. This results capability for the gas sensor to be prevented from generating an output deviation due to the presence of hydrogen gas.

Further, the catalyst-supported trap layer 2 has an average film thickness “d” falling in a value ranging from 20 to 200 μm and the amount of supported catalyst particles 22 is selected to fall in a value ranging from 0.1 to 2 wt %. That is, the catalyst-supported trap layer 2 is formed in a structure with an adequately large average film thickness “d” while containing the catalyst particles 22 supported in an adequately small support concentration. In addition, the catalyst particles 22 have a dispersion degree falling in a value ranging from 0.005 to 0.1 pieces/μm². That is, the catalyst particles 22 of the catalyst-supported trap layer 2 have an adequately low value of the dispersion degree representing the number of the catalyst particles 22 per unit surface area in the catalyst-supported trap layer 2. Adopting such a structure mentioned above enables the prevention of degradation in responsiveness of the gas sensor and output deviation thereof, while suppressing the occurrence of endurance deterioration.

That is, such a structure, mentioned above, can suppress the noble metal components of the catalyst particles 22 from extremely coming close to each other. Thus, even under circumstances where the gas sensor is used under high temperature environments, no aggregation takes place between the noble metal particles. Therefore, no degraded duration takes place in catalytic ability with the use of the gas sensor. Even after an elapse of endurance, the catalyst particles 22 can adequately combust hydrogen gas.

Further, as set forth above, the presence of the adequately low support amount and low value of the dispersion degree of the catalyst particles 22 prevents measuring gas from excessively adsorbing to the catalyst-supported trap layer 2. This also prevents an increase in arrival time of oxygen gas reaching the measuring gas detecting electrode 14, thereby preventing the occurrence of deteriorated responsiveness of the gas sensor.

Furthermore, since the average film thickness of the catalyst-supported trap layer 2 is selected to lien in a value less than 200 μm, no probability takes place for the catalyst-supported trap layer 2 from being peeled off from the outer side surface 12a of the diffusion resistance layer 12.

Moreover, no need arises for the catalyst-supported trap layer 2 to support an excessive amount of catalyst particles, enabling a reduction in production cost of the gas sensor element 1.

Since the metal oxide particles 21 of the catalyst-supported trap layer 2 are composed of alumina particles having the γ- or θ-crystal structure, the catalyst-supported trap layer 2 is made of alumina particles with adequately large surface areas. Therefore, a given amount of catalyst particles 22 can be dispersed in the catalyst-supported trap layer 2 in a uniformly dispersed pattern without causing the catalyst particles 22 to come close to each other.

Moreover, with the metal oxide particles 21 having the particle diameters in a value ranging from 1 to 50 μm, the catalyst-supported trap layer 2 has a porosity rate of 40 to 70% with the average pore size diameter of the value ranging from 0.1 to 10 μm. This allows the metal oxide particles 21 to have adequately large surface areas for supporting the catalyst particles 22, while enabling the catalyst-supported trap layer 2 to be available to permeate measuring gas in an adequate volume. In addition, harmful substances (toxic substances such as Pb, P, S or the like), harmful for electrode materials of the measuring gas detecting electrode 14 and the reference gas detecting electrode 15, to be prevented from approaching to the measuring gas detecting electrode 14 and the reference gas detecting electrode 15.

Further, the catalyst-supported trap layer 2 is formed not only on the outer side surface 12a of the diffusion resistance layer 12 but also in an area placed at a position distanced from the outer side surface 12a by a value ranging from 20 to 200 μm. This enables measuring gas to travel through the catalyst-supported trap layer 2 in an adequately extended length, making it possible to avoid hydrogen gas in measuring gas from reaching the measuring gas detecting electrode 14 while achieving a reduction in production cost of the gas sensor element 1.

Furthermore, since the catalyst particles 22 are composed of at least one kind of material selected from the group consisting of Pt, Rh and Pd. the gas sensor element 1 can be manufactured using the catalyst particles 22 that can achieve optimal efficacy with minimal toxicity.

Moreover, the diffusion resistance layer 12 comprises a porous body made of alumina or zirconium with the diffusion distance L set to a value greater than 0.2 mm, adequately providing advantageous effects of the present invention. That is, even with the gas sensor element 1 formed in such a structure with an increase in difference between time needed for oxygen gas to arrive at the measuring gas detecting electrode 14 and time needed for hydrogen gas to arrive the measuring gas detecting electrode 14, the use of the catalyst-supported trap layer 2 adequately prevents the occurrence of output deviation of the gas sensor.

In addition, since the catalyst particles 22 has the noble metal particles falling in a value ranging from 0.05 to 0.5 μm, no deterioration takes place in activity of the catalyst-supported trap layer 2, while preventing the occurrence of aggregation of the noble metal particles of the catalyst particles 22 under high temperature environments.

Since the amount of the supported catalyst particles 22 per unit surface area of the metal oxide particles 22 forming the catalyst-supported trap layer 2 lies in a value ranging from 7×10⁻⁶ to 2.9×10⁻⁴ g/m², the gas sensor element 1 of the present embodiment can achieve various advantageous effects of the present invention.

Since the gas sensor element 1 has activity time less than five seconds, the gas sensor employing the gas sensor element 1 of the present embodiment can provide a normal sensor output on an early stage immediately after a startup of an internal combustion engine to be more important in accurately measuring a specified gas concentration in measuring gas.

Further, in order to render the gas sensor to have activity on an earlier stage, the gas sensor element 1 needs to have a decreased heat capacity with a minimized structure. In such a case, during operation of the gas sensor with the gas sensor element exposed to exhaust gases at high temperatures, the catalyst-supported trap layer 2 is liable to easily suffer further increased heat damage. It is highly significant from the perspective of the above view to apply the present invention to the gas sensor element with activity time of a value less than five seconds for providing improved heat resistance.

As set forth above, with the present embodiment according to the present invention, a gas sensor element can be provided in a structure that prevents deterioration in responsiveness and the occurrence of output deviation while enabling the suppression of endurance deterioration of catalyst ability.

Further, while the diffusion resistance layer 12 can support catalyst particles, the amount of supported catalyst particles may preferably lie in a value less than 0.1 wt % for the purpose of preventing excessive adsorption of measuring gas.

Furthermore, the protective trap layer 3 can support the catalyst particles. However, the protective trap layer 3 may not preferably have the catalyst particles with a view to preventing excessive adsorption of measuring gas and improving production efficiency.

Moreover, while the gas sensor element 1 of the present embodiment is provided with the protective trap layer 3, the protective trap layer 3 may be omitted.

### Second Embodiment

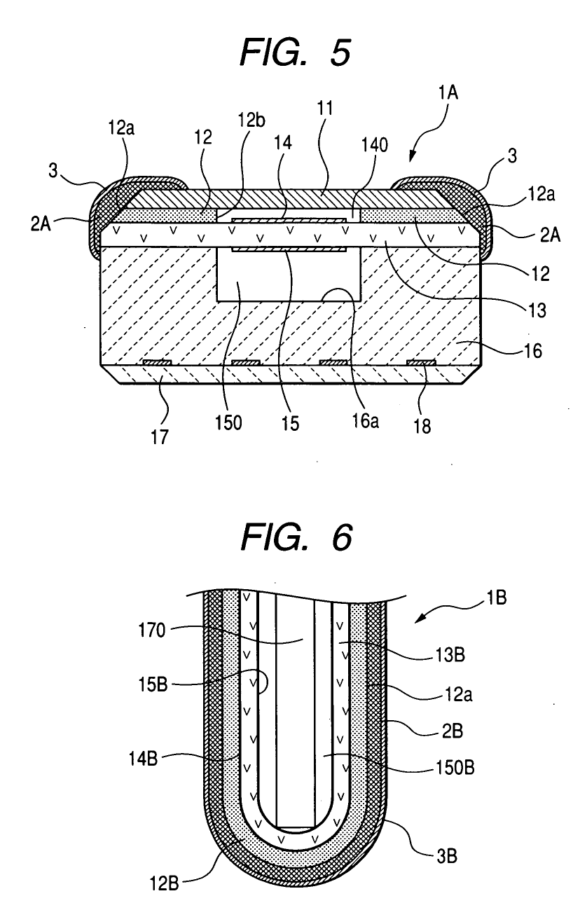

A gas sensor element of a second embodiment according to the present invention is described below with reference to FIG. 5.

With a structure shown in FIG. 5, the gas sensor element 1A includes a catalyst-supported trap layer 2A formed in a widened area. That is, the catalyst-supported trap layer 2A is formed not only on the outer side surface 12a of the catalyst-supported trap layer 2 but also on a side peripheral surface of the solid electrolyte body 13, a portion of a side peripheral surface of the reference gas chamber forming layer 16 and an area covering a side peripheral surface of and an adjacent upper surface area of the shielding layer 11. The gas sensor element 1A is similar in other structure to that of the gas sensor element 1 of the first embodiment shown in FIG. 3 and, hence, detailed description of the same is herein omitted.

With the present embodiment, the gas sensor element 1A can be formed in a structure that allows measuring gas to surely travel through the catalyst-supported trap layer 2 in an adequately extended length, thereby preventing hydrogen gas of measuring gas from arriving at the measuring gas detecting electrode 14 in a reliable manner.

The gas sensor element 1A of the present embodiment has the same other advantages as those of the gas sensor element 1 of the first embodiment and, hence, description of the same is herein omitted.

Also, the catalyst-supported trap layer 2 may be formed on an entire surface of the gas sensor element 1A.

### Third Embodiment

A gas sensor element of a third embodiment according to the present invention is described below with reference to FIG. 6.

With a structure shown in FIG. 6, the gas sensor element 1B includes a bottomed, cylindrical solid electrolyte body 13B, a reference gas detecting electrode 15B formed on an inner peripheral wall of the solid electrolyte body 13B, and a measuring gas detecting electrode 14B formed on an outer peripheral surface of the solid electrolyte body 13B. In addition, the solid electrolyte body 13B is formed with a reference gas chamber 150B to which a heater 170 is inserted and placed in a fixed position.

Further, a diffusion resistance layer 12B is formed on an entire surface of the outer peripheral surface of the solid electrolyte body 13B and a catalyst-supported trap layer 2B is formed on an entire surface of the outer peripheral surface of the diffusion resistance layer 12B.

The gas sensor element 1B of the present embodiment is similar in other structure to that of the gas sensor element of the first embodiment and has the same advantages as those of the same.

### Fourth Embodiment

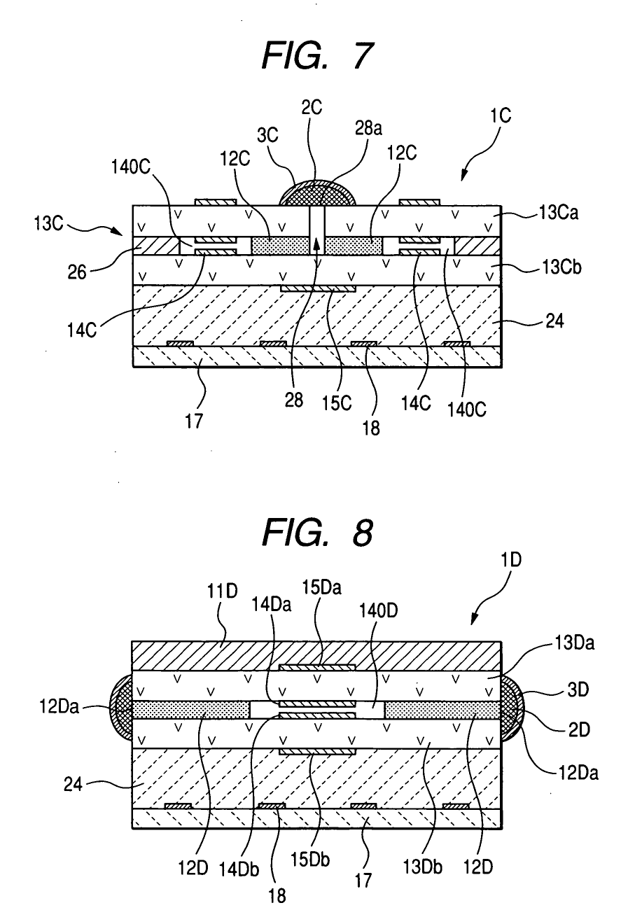

A gas sensor element of a fourth embodiment according to the present invention is described below with reference to FIG. 7.

With a structure shown in FIG. 7, the gas sensor element 1C includes a main substrate 24 having one surface carrying thereon a solid electrolyte body unit 13C and the other surface on which a heater substrate 17 is stacked. A plurality of heater elements 18 is disposed between the main substrate 24 and the heater substrate 17.

A reference gas detecting electrode 15C is interposed between the main substrate 24 and the solid electrolyte unit 13C. The solid electrolyte unit 13C comprises first and second solid electrolyte bodies 13Ca, 13Cb that are spaced from each other by means of a spacer 26. A diffusion resistance layer 12C is sandwiched in a central area between the first and second solid electrolyte bodies 13Ca, 13Cb, thereby defining a measuring gas chamber 140C.

The second solid electrolyte body 13Ca has one surface formed with a measuring gas detecting electrode 14C that is exposed to the measuring gas chamber 140C.

A guide hole 28 extends through the first solid electrolyte body 13Ca and the diffusion resistance layer 12C. In addition, a catalyst-supported trap layer 2C is disposed on an upper surface of the first solid electrolyte body 13Ca in a position to cover an opening 28a of the guide hole 28, with the catalyst-supported trap layer 2C covered with a protective trap layer 3C.

With such a structure of the gas sensor element 1C of the present embodiment, measuring gas passes through the protective trap layer 3C and the catalyst-supported trap layer 2C and flows through the guide hole 28, upon which measuring gas flows through the diffusion resistance layer 12C into the measuring gas chamber 140C.

The gas sensor element 1C of the present embodiment operates in the same manner as that in which the gas sensor element 1 of the first element operates, with the same advantageous effects as those of the same being obtained.

### Fifth Embodiment

A gas sensor element of a fifth embodiment according to the present invention is described below with reference to FIG. 8.

With a structure shown in FIG. 8, the gas sensor element ID includes first and second solid electrolyte bodies 13Da, 13Db that are spaced from each other by a given distance by means of a spacer (not shown). A diffusion resistance layer 12D is sandwiched between the first and second solid electrolyte bodies 13Da, 13Db, thereby defining a measuring gas chamber 140D. The first solid electrolyte body 13Da has one surface formed with a measuring gas detecting electrode 14Da and the other surface formed with a reference gas detecting electrode 15Da. Likewise, the second solid electrolyte body 13Db has one surface formed with a measuring gas detecting electrode 14Db and the other surface formed with a reference gas detecting electrode 15Db. Further, the gas sensor element 1D includes a catalyst-supported trap layer 2D formed on side surfaces of the first and second solid electrolyte bodies 13Da, 13Db and a side surface of the diffusion resistance layer 12D, with the catalyst-supported trap layer 2D covered with a protective trap layer 3D.

With such a structure of the gas sensor element ID of the present embodiment, measuring gas passes through the protective trap layer 3D and the catalyst-supported trap layer 2D and flows through the diffusion resistance layer 12D into the measuring gas chamber 140D.

The gas sensor element 1D of the present embodiment operates in the same manner as that in which the gas sensor element 1 of the first element operates, with the same advantageous effects as those of the same being obtained.

### FIRST EXAMPLE

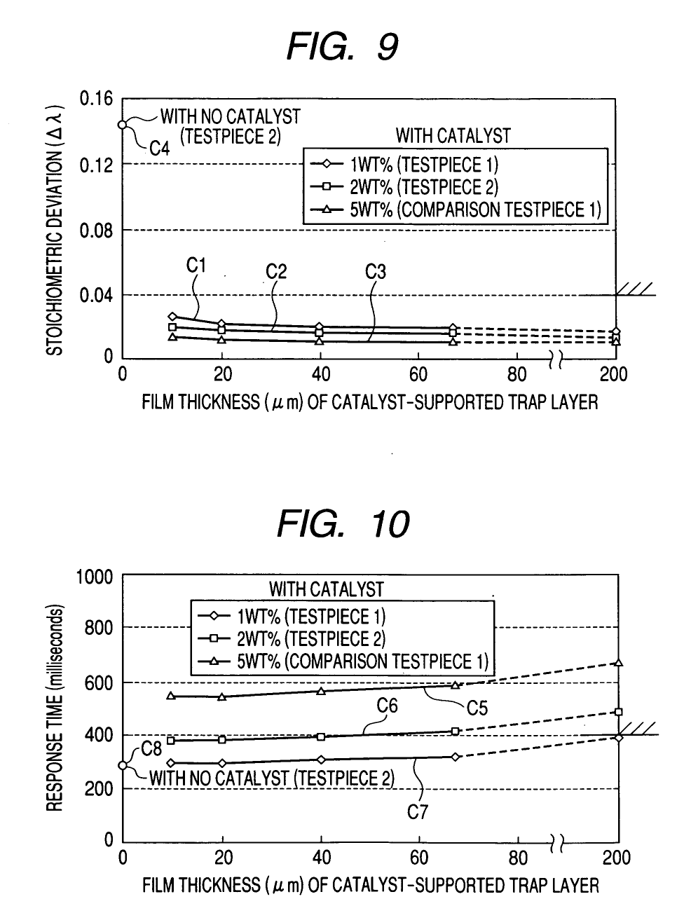

Test results on the gas sensor element of the first embodiment are described below with reference to FIGS. 9 to 11.

FIG. 9 is a graph showing test results of specimens, manufactured based on the gas sensor element 1 of the first embodiment, and a gas sensor element, manufactured as a comparison specimen, in terms of the relationship between an early stoichiometric deviation (Δλ) (that is a deviation between a theoretical air fuel ratio and an actual measurement value), appearing before and after the endurance of the gas sensor element 1 of the first embodiment, and an average film thickness “d” of the catalyst-supported trap layer 2. This graph represents variations in responsiveness of the gas sensor element 1 on an initial stage thereof with the supported amount of catalyst particles 22 being varied with respect to a gross weight of the catalyst-supported trap layer 2.

More particularly, a curve C1 represents variation in early stoichiometric deviation Δλ of the specimen 1 with 1 wt % of the supported catalyst amount. A curve C2 represents variation in early stoichiometric deviation Δλ of the specimen 2 with 2 wt % of the supported catalyst amount and a curve C3 represents variation in early stoichiometric deviation Δλ of the comparison specimen 1 with 5 wt % of the supported catalyst amount. In addition, reference C4 represents variation in early stoichiometric deviation Δλ of the comparison specimen 2 in the absence of catalyst in the catalyst-supported trap layer.

Here, the same component parts as those of the gas sensor element 1 of the first embodiment bear like reference numerals.

For tests to be conducted, a first gas sensor element was prepared as a specimen 1 with a catalyst-supported trap layer adjusted to have 1 wt % of the supported catalyst amount relative to a gross weight of the catalyst-supported trap layer. Likewise, a second gas sensor element was prepared as a specimen 2 with a catalyst-supported trap layer adjusted to have 2 wt % of the supported catalyst amount relative to a gross weight of the catalyst-supported trap layer.

In addition, a third gas sensor element was prepared as a comparison specimen 1 with a catalyst-supported trap layer adjusted to have 5 wt % of the supported catalyst amount relative to a gross weight of the catalyst-supported trap layer. Moreover, a fourth gas sensor element was prepared as a comparison specimen 2 with no catalyst supported in the catalyst-supported trap layer.

Gas sensors, employing respective specimens, were placed in an electrical furnace kept under an atmospheric environment maintained at a temperature of 900° C. and endurance tests were conducted upon placing the gas sensors under such a condition for 500 hours. It has already been confirmed that such a condition corresponds to a status appearing when a motor vehicle is caused to bear endurance upon running one hundred fifty thousand miles in actual practice.

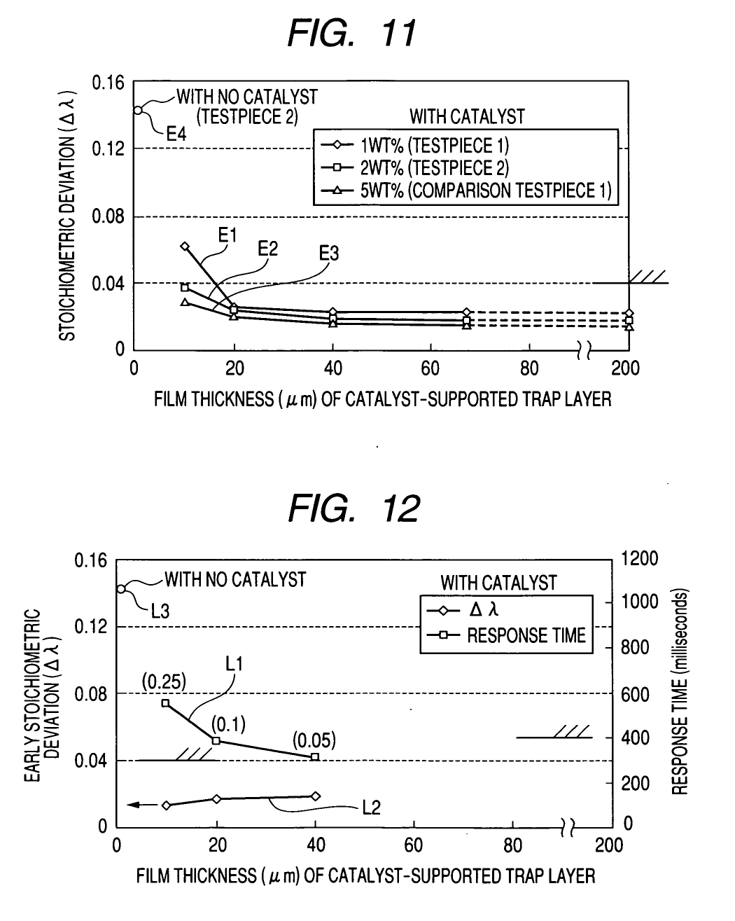

FIG. 9 shows the test results before the gas sensor elements bear respective endurances. FIG. 10 shows test results on responsiveness of the gas sensor elements bear respective endurances and FIG. 11 shows test results after the gas sensor elements bore respective endurances.

As will be apparent from FIGS. 9 and 11, the early stoichiometric deviations of the gas sensor elements vary such that the greater the amount of supported catalyst relative to the gross weight of the catalyst-supported trap layer, the less will be the early stoichiometric deviation Δλ of the gas sensor element.

Moreover, with the catalyst-supported trap layer formed with an average film thickness “d” greater than 20 μm, the early stoichiometric deviations Δλ could be reduced to be less than 0.04 in any of the specimens 1 and 2 and the comparison specimen 1.

In FIG. 11, a curve E1 represents variation in stoichiometric deviation Δλ of the specimen 1 with 1 wt % of the supported catalyst amount. A curve E2 represents variation in stoichiometric deviation Δλ of the specimen 2 with 2 wt % of the supported catalyst amount and a curve E3 represents variation in stoichiometric deviation Δλ of the comparison specimen 1 with 5 wt % of the supported catalyst amount. In addition, reference E4 represents variation in stoichiometric deviation Δλ of the comparison specimen 2 in the absence of catalyst in the catalyst-supported trap layer.

Meanwhile, the comparison specimen 2 with no catalyst supported in the catalyst-supported trap layer revealed the early stoichiometric deviations Δλ at an extremely higher level than those achieved with the other specimens.

From the above, it will be clear that the presence of the supported catalyst in the catalyst-supported trap layer can achieve remarkable reduction in the early stoichiometric deviation Δλ of the gas sensor element and forming the catalyst-supported trap layer in an average film thickness greater than 20 μm enables the gas sensor element to generate an output with a minimized early stoichiometric deviations Δλ even upon endurance use.

As will be understood from FIG. 10, further, the comparison specimen 1 with 5 wt % of the supported catalyst amount has response time greater than 400 milliseconds with a drop in responsiveness to a lower value than those of the specimens 1 and 2 (see a curve C5). In contrast, the specimens 1 and 2 can have response time less than 400 milliseconds (see curves C6 and 7). Reference C8 represents response time of a gas sensor element of the comparison specimen 2 in the absence of the catalyst.

That is, upon consideration of responsiveness of the gas sensor element on an initial stage thereof, the gas sensor element may include the catalyst-supported trap layer with the supported catalyst amount less than 2 wt %.

From the above results, it will be understood that, for the sake of having preferable advantages, the gas sensor element may preferably include the catalyst-supported trap layer with an average film thickness greater than 20 μm and the supported catalyst amount selected to be less than 2 wt %.

### SEVENTH EXAMPLE

A gas sensor element of a second example is described below with reference to FIG. 12.

FIG. 12 is a graph showing test results of a specimen, manufactured based on the gas sensor element 1 of the first embodiment, and a gas sensor element, manufactured as a comparison specimen, in terms of an early stoichiometric deviation (Δλ) and response time of the gas sensor element on an initial stage thereof upon changing an average film thickness “d” of the catalyst-supported trap layer while altering a concentration and dispersion rate of the catalyst without causing a change on an absolute amount of noble metal particles in catalyst.

In FIG. 12, a curve L1 represents a response time of the gas sensor element on an initial stage thereof and a curve L2 represents the early stoichiometric deviations Δλ of the gas sensor element. Reference L3 represents the early stoichiometric deviations Δλ of the gas sensor element manufactured in the absence of the catalyst.

In addition, parenthetical references in FIG. 12 indicate dispersion degrees (pieces/μm²) of catalyst parcels contained in the catalyst-supported trap layer. Moreover, reference F represents variation in early stoichiometric deviation Δλ of the comparison specimen 2 in the absence of catalyst in the catalyst-supported trap layer.

Here, the same component parts as those of the gas sensor element 1 of the first embodiment bear like reference numerals.

As will be apparent from the curve L1 in FIG. 12, the gas sensor element including the catalyst-supported trap layer, formed in an average film thickness less than 20 μm, has a response time greater than approximately 400 milliseconds. On the contrary, it is understood that selecting the average film thickness to be greater than 20 μm results in an increased improvement in response time.

Further, as will be apparent from the curve L2 in FIG. 12, the early stoichiometric deviation Δλ of the gas sensor element before the endurance use is suppressed to a value below 0.04.

### Sixth Embodiment

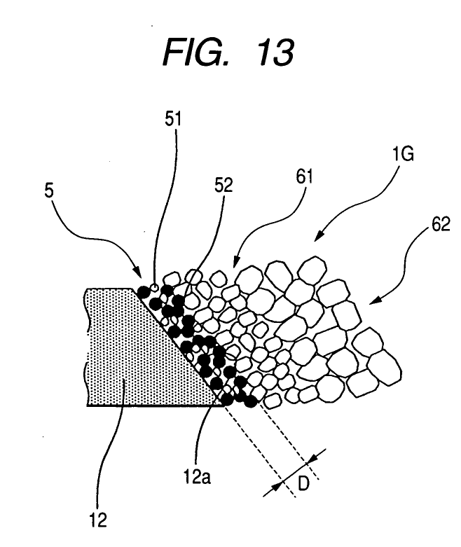

A gas sensor element of a sixth embodiment according to the present invention is described below with reference to FIG. 13.

As shown in FIG. 13, the gas sensor element 1G has the same structure as that of the gas sensor element 1 of the first embodiment except for the catalyst-supported trap layer. That is, the gas sensor element 1G of the present embodiment comprises a catalyst layer 5 held in contact with the outer side surface 12a of the diffusion resistance layer 12. The catalyst layer 5 comprises a large number of catalysts 52 and a large number of aid materials 51 uniformly dispersed in the large number of catalyst 52.

The catalysts 52 have an average particle diameter falling in a value ranging from 0.5 to 5 μm.

Further, the aid materials 51 have an average particle diameter falling in a value ranging, for instance, from 0.2 to 5 μm.

The catalyst layer 5, formed in an average film thickness D of 5 to 50 μm, has the catalyst 52 with noble metal particles contained in 10 to 80 wt % of gross weight with respect to a gross weight of the catalyst layer 5 and has a porosity rate of 15 to 50%.

During production, a paste for the catalyst layer 5 is coated on the outer side surface 12a of the diffusion resistance layer 12 and, thereafter, the paste is heat treated at a temperature higher than 900° C., thereby forming the catalyst layer 5.

In addition, the aid material is made of alumina particles and the catalysts 52 are composed of at least one kind selected from the group consisting of platinum (Pt) and rhodium (Rh).

As shown in FIG. 13, the gas sensor 1G of the present embodiment further comprises a first trap layer 61, composed of alumina particles with γ crystal structure, and a second trap layer 62, composed of alumina particles larger in particle diameter than those of the first trap layer 61.

The gas sensor 1G of the present embodiment has advantageous effects as described below.

As shown in FIG. 13, the gas sensor 1G of the present embodiment comprises the catalyst layer 5 composed of a mixture of the aid materials 51 and the catalyst 52. Therefore, the presence of the catalyst layer 5 enables hydrogen gas to be adequately combust, achieving a remarkable reduction of a volume of hydrogen gas arriving at the measuring gas detecting electrode 14.

This results in capability of preventing the occurrence of output deviation of a gas sensor resulting from hydrogen gas.

Further, the catalysts 52 include noble metal particles with an average particle diameter of a value ranging from 0.5 to 5 μm. That is, the noble metal particles of the catalyst 52 have a relatively large average particle diameter. This result in capability of obtaining the gas sensor element that can prevent degraded responsiveness and output deviation while enabling the suppression of endurance deterioration of the catalyst.

That is, under circumstances where the gas sensor incorporating the gas sensor element of the present embodiment is exposed to high temperature environments, that is, for instance, when a vehicle is running at a high speed, an engine control unit operates to perform feedback control of an internal combustion engine so as to prepare a rich air fuel mixture for the purpose of improving fuel consumption. In a case where the noble metal particles of the catalyst layer 5 has a small average particle diameter, a risk occurs for the catalyst layer 5 from evaporating or agglutinating to cause deterioration in catalyst.

On the contrary, in a case where the noble metal particles of the catalyst layer 5 have the average particle diameter as large as a value ranging from 0.5 to 5 μm, the evaporation or agglutination of the noble metal particles can be prevented to occur in the catalyst layer 5. This result in capability of suppressing deterioration of catalyst ability and preventing degradation of response and output deviation of the gas sensor element, while making it possible to prevent endurance deterioration of catalyst ability.

The catalyst layer 5 has the average film thickness in a range from 5 to 50 μm and the noble metal particles of the catalyst 52 relative to the gross weight of the catalyst layer 5 have 10 to 80 wt % of gross weight and has a porosity of 15 to 50%. This prevents deterioration of response and output deviation of the gas sensor in a further effective fashion.

Further, the aid materials 51 are composed of alumina particles. This enables an adequate reduction in difference of the thermal expansion coefficient between the diffusion resistance layer 12 and the catalyst layer 5. Therefore, even with the gas sensor exposed to thermal shock cycle in repeated frequency, the gas sensor element of the present embodiment can prevent the occurrence of cracking or peeling between the diffusion resistance layer 12 and the catalyst layer 5. In addition, forming the catalyst layer 5 with the substantially same material as that of the diffusion resistance layer 12 enables the diffusion resistance layer 12 and the catalyst layer 5 to be adequately bonded to each other in increased bonding strength.

Moreover, the paste is printed on the outer side surface 12a of the diffusion resistance layer 12 and, subsequently, the paste is heat treated at the temperature of 900° C. to form the catalyst layer 5. This prevents a drop in catalyst ability, making it possible to adequately improve durability and responsiveness of the catalyst 52.

As set forth above, the gas sensor element of the present embodiment enables the provision of a gas sensor that can prevent deterioration in responsiveness and output deviation while suppressing endurance deterioration of catalyst ability.

### THIRD EXAMPLE

FIG. 14 is a graph showing the relationship between a particle diameter of noble metal particles of the catalyst layer 5 and a particle diameter change rate of the noble metal particles on stages before and after endurance use of a gas sensor. That is, change rates of particle diameters were measured upon placing the catalyst layer 5 with various particle diameters in conditions subjected to endurance tests at temperatures 900° C., 950° C. and 1000° C. for 200 hours.

In FIG. 14, a curve G1 represents a particle diameter change rate caused in the particle diameters of the gas sensor element that were measured after the endurance test was conducted at 1000° C. A curve G2 represents the particle diameter change rate caused in the particle diameters of the gas sensor element that were measured after the endurance test was conducted at 950° C. Reference G3 represents the particle diameter change rate caused in the particle diameters of the gas sensor element that were measured after the endurance test was conducted at 900° C.

In addition, the same component parts of the gas sensor element, subjected to the endurance tests, as those of the gas sensor element shown in FIG. 13 bear like reference numerals.

As will be clear from FIG. 14, in a case where the particle diameter is greater than 0.5 μm, the particle diameter change rate of the noble metal particles of the catalyst 52 takes a value less than 10% that is sufficiently low in level. On the contrary, if the endurance test is conducted at the temperature higher than 950° C. with the gas sensor element having the noble metal particles with the particle diameter selected to be less than 0.5 μm, the particle diameter change rate of the noble metal particles of the catalyst 52 exceeds a value of 10% that is high in level.

As will be understood from the foregoing description, with the catalyst 52 containing the noble metal particles whose particle diameter takes a value greater than 0.5 μm, even if the gas sensor element is subjected to severe usage environments under high temperature atmosphere at the temperature of 1000° C., no probability occurs for the noble metal particles to agglutinate with each other to cause a change in particle diameter.

### FOURTH EXAMPLE

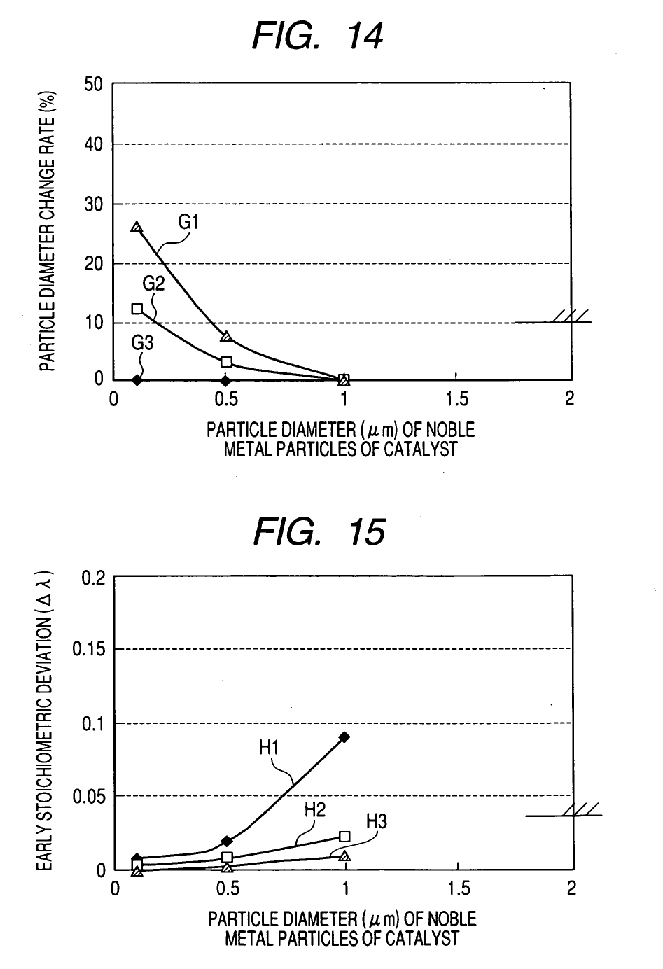

FIG. 15 shows a test result conducted on gas sensor elements having a catalyst layer 5 formed in an average film thickness D of 10 μm showing an early stoichiometric deviation Δλ on an initial stage upon variously changing the particle diameter of the noble metal particles of the catalyst 52 in a range from 0.1 to 1 μm.

In addition, the same component parts of the gas sensor element, subjected to the endurance tests, as those of the gas sensor element shown in FIG. 13 bear like reference numerals.

In FIG. 15, a curve H1 represents an early stoichiometric deviation Δλ on an initial stage of a gas sensor element containing a gross weight of 1 wt % of noble metal particles, forming the catalyst 52, with respect to a gross weight of the catalyst layer 5. A curve H2 represents an early stoichiometric deviation Δλ on an initial stage of another gas sensor element containing a gross weight of 10 wt % of noble metal particles forming the catalyst 52. A curve H3 represents an early stoichiometric deviation Δλ on an initial stage of still another gas sensor element containing a gross weight of 80 wt % of noble metal particles forming the catalyst 52.

As will be understood from FIG. 15, in a case where a proportion of the gross weight of the catalyst 52 is greater than 10 wt %, even if the particle diameter of the noble metal particles is caused to increase, the gas sensor element can have a minimized early stoichiometric deviation Δλ on an initial stage as low as a value less than 0.4.

On the contrary, in another case where the proportion of the gross weight of the catalyst 52 is 1 wt %, if the particle diameter of the noble metal particles is selected to have a value of 1 μm, the gas sensor element can have an early stoichiometric deviation Δλ on an initial stage exceeding a value of 0.4, marking a large value. As will be clear from the foregoing description, the proportion of the gross weight of the catalyst 52 may be preferably selected to be greater than 10 wt % in the light of minimizing the early stoichiometric deviation Δλ.

### FIFTH EXAMPLE

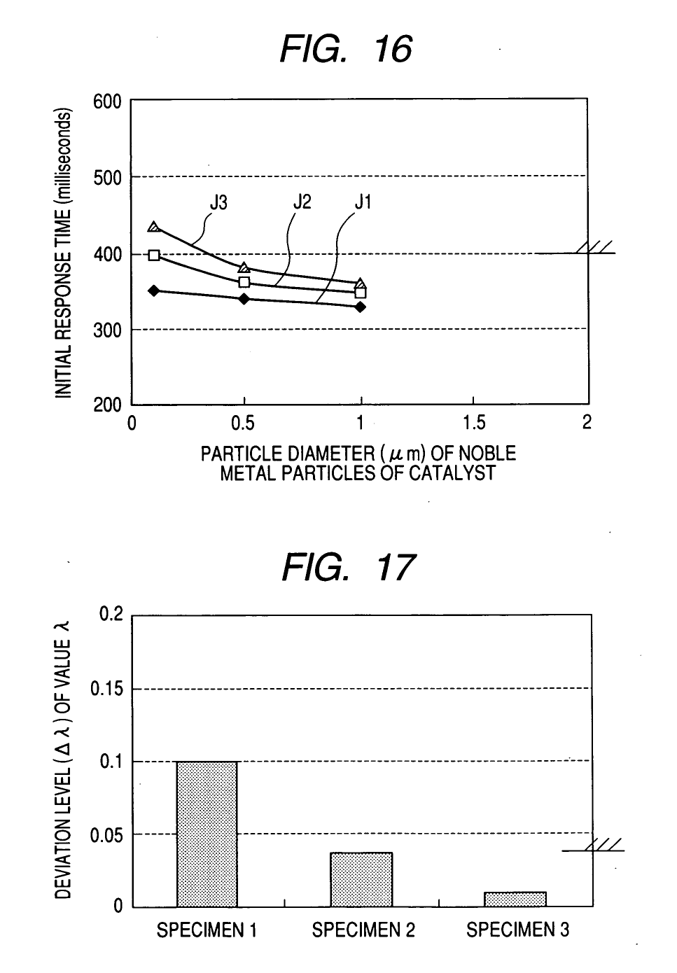

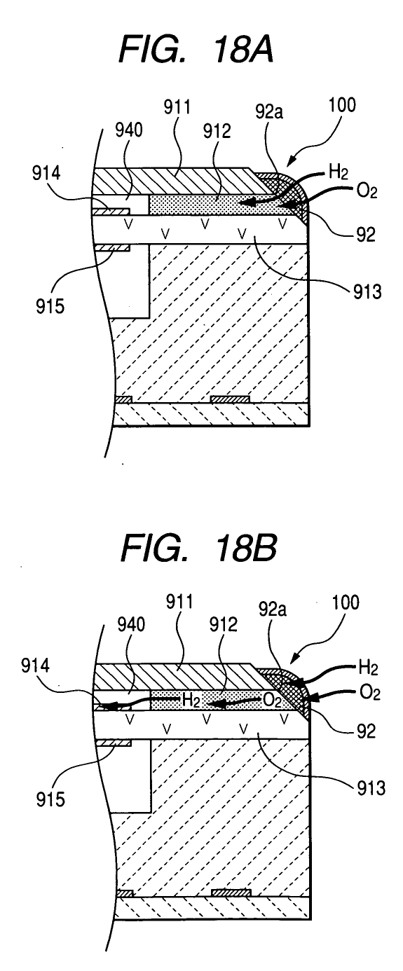

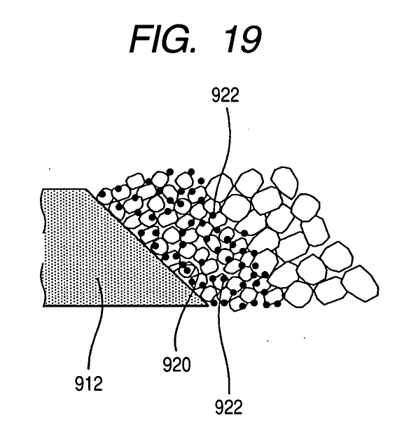

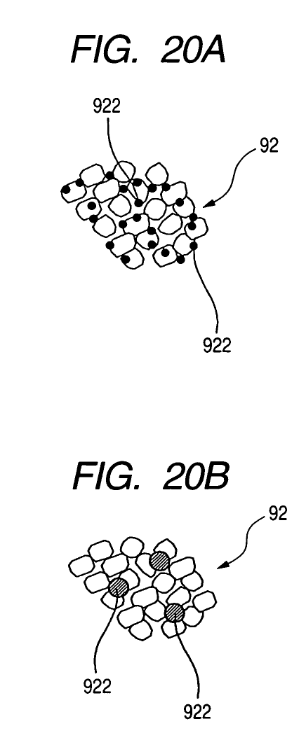

FIG. 16 is a graph showing a test result conducted on gas sensor elements for illustrating an initial responsiveness thereof upon variously changing a particle diameter of noble metal particles of the catalyst 52.

The same component parts of the gas sensor element as those of the gas sensor element shown in FIG. 13 bear like reference numerals.

In FIG. 16, a curve J1 represents an initial response time of a gas sensor element containing a gross weight of 1 wt % of noble metal particles, forming the catalyst 52, with respect to a gross weight of the catalyst layer 5. A curve J2 represents an initial response time of another gas sensor element containing a gross weight of 10 wt % of noble metal particles forming the catalyst 52. A curve J3 represents an initial response time of still another gas sensor element containing a gross weight of 80 wt % of noble metal particles forming the catalyst 52.

As will be understood from FIG. 16, in a case where a proportion of the gross weight of the catalyst 52 is less than 80 wt % and the noble metal particles have an average particle diameter greater than 0.5 μm, the gas sensor element can have an initial response time less than 400 milliseconds. On the contrary, in another case where the proportion of the gross weight of the catalyst 52 is 80 wt % and the noble metal particles have the average particle diameter less than 0.5 μm, the initial response time of the gas sensor element exceeds a value of 400 milliseconds with the resultant occurrence of inadequate initial response.

As will be clear from the foregoing description, the average particle diameter of the noble metal particles may be preferably selected to be greater than 0.5 μm while selecting a proportion of the gross weight of the catalyst 52 to be less than 80 wt % in the light of getting early activity of the gas sensor.

### SIXTH EXAMPLE

FIG. 17 is a graph showing test results coming from specimens prepared upon variously altering an average diameter of the noble metal particles of the catalyst 52, a gross weight of the noble metal particles of the catalyst 52 with respect to a gross weight of the catalyst layer 5, and an average film thickness D upon which deviation levels Δλ on a value λ on stages before and after endurance tests of the specimens.

The same component parts of the gas sensor element as those of the gas sensor element shown in FIG. 13 bear like reference numerals.

In the present Example, for a specimen 1, a gas sensor element was prepared with the catalyst 52 containing noble metal particles with an average particle diameter of 0.1 μm and having 5 wt % gross weight of the noble metal particles of the catalyst 52 with respect to a gross weight of the catalyst layer 5 which had an average film thickness D of 10 μm. For a specimen 2, a gas sensor element was prepared with the catalyst 52 containing noble metal particles with an average particle diameter of 0.1 μm and having 1 wt % gross weight in a proportion of the gross weight of the catalyst layer 5 which had an average film thickness D of 60 μm. For a specimen 3, a gas sensor element was prepared with the catalyst 52 containing noble metal particles with an average particle diameter of 0.7 μm and having 80 wt % gross weight in a proportion of the gross weight of the catalyst layer 5 which had an average film thickness D of 10 μm.

These three specimens were exposed to exhaust gases at a temperature of 1000° C. for 200 hours for performing endurance test, upon which an air fuel ratio of given measuring gas was measured using these specimens after subjected to the endurance tests. The deviation levels Δλ on the value λ on stages before and after endurance tests of the specimens were calculated on the basis of the resulting measuring results and measuring results before the endurance tests being conducted.

As will be apparent from FIG. 17, the specimens 1 and 2 had the deviation level Δλ greater than 0.04, marking high levels. In contrast, the specimen 3 had the deviation level Δλ less than 0.04, marking a small level. It is thus concluded that permitting the catalyst 52 to have noble metal particles with adequately increased particle diameter while increasing a mixture ratio of the catalyst 5 to an adequate level enables the catalyst layer 5 to have improved durability.

As will be clear from the test results shown in the graphs of FIGS. 14 to 17, the average particle diameter of the noble metal particles forming the catalyst 52 may be preferably selected to be greater than 0.5 μm while permitting a gross weight of the noble metal particles to lie in a value ranging from 10 to 80 wt % and having an average film thickness D in a range from 5 to 50 μm in the light of achieving a reduction in the deviation level Δλ after the endurance test.

While the specific embodiment of the present invention has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A gas sensor element comprising:
a solid electrolyte body having oxygen ion conductivity;
a measuring gas detecting electrode formed on one surface of the solid electrolyte body;
a reference gas detecting electrode formed on the other surface of the solid electrolyte body;
a diffusion resistance layer formed on the one surface of the solid electrolyte body so as to surround the measuring gas detecting electrode and available to permeate measuring gas to the measuring gas detecting electrode; and
a catalyst-supported trap layer formed on an outer side surface of the diffusion resistance layer;
wherein the catalyst-supported trap layer is composed of a large number of metal oxide particles and catalyst supported on the metal oxide particles and has an average film thickness of a value ranging from 20 to 200 μm; and
an amount of the supported catalyst with respect to a gross weight of the catalyst-supported trap layer lies in a value ranging from 0.1 to 2 wt %.

2. The gas sensor element according to claim 1, wherein:
the metal oxide particles are composed of alumina particles having a γ- or θ-crystal structure.

3. The gas sensor element according to claim 1, wherein:
the metal oxide particles have an average particle diameter of a value ranging from 1 to 50 μm; and
the catalyst-supported trap layer has a porosity of a value ranging from 40 to 70% with an average pore size diameter of a value ranging from 0.1 to 10 μm.

4. The gas sensor element according to claim 1, wherein:
the catalyst-supported trap layer is formed on the outer side surface of the diffusion resistance layer and extends in an area located at a position distanced from the outer side surface by a value ranging from 20 to 200 μm.

5. The gas sensor element according to claim 1, wherein:
the catalyst includes noble metal particles having an average particle diameter of a value ranging from 0.05 to 0.5 μm.

6. The gas sensor element according to claim 1, wherein:
an amount of the supported catalyst particles per unit surface area of the metal oxide particles forming the catalyst-supported trap layer lies in a value ranging from 7×10⁻⁶ to 2.9×10⁻⁴ g/m².

7. A gas sensor element comprising:
a solid electrolyte body having oxygen ion conductivity;
a measuring gas detecting electrode formed on one surface of the solid electrolyte body;
a reference gas detecting electrode formed on the other surface of the solid electrolyte body;
a diffusion resistance layer formed on the one surface of the solid electrolyte body so as to surround the measuring gas detecting electrode and available to permeate measuring gas to the measuring gas detecting electrode; and
a catalyst-supported trap layer supporting a catalyst formed on an outer side surface of the diffusion resistance layer;
wherein the catalyst-supported trap layer is composed of a large number of metal oxide particles and catalyst supported on the metal oxide particles in a dispersion degree ranging from 0.005 to 0.1 piece/μm².

8. The gas sensor element according to claim 7, wherein:
the metal oxide particles are composed of alumina particles having a γ- or θ-crystal structure.

9. The gas sensor element according to claim 7, wherein:
the metal oxide particles have an average particle diameter of a value ranging from 1 to 50 μm; and
the catalyst-supported trap layer has a porosity of a value ranging from 40 to 70% with an average pore size diameter of a value ranging from 0.1 to 10 μm.

10. The gas sensor element according to claim 7, wherein:
the catalyst-supported trap layer is formed on the outer side surface of the diffusion resistance layer and extends in an area located at a position distanced from the outer side surface by a value ranging from 20 to 200 μm.

11. The gas sensor element according to claim 7, wherein:
the catalyst includes noble metal particles having an average particle diameter of a value ranging from 0.05 to 0.5 μm.

12. The gas sensor element according to claim 7, wherein:
an amount of the supported catalyst particles per unit surface area of the metal oxide particles forming the catalyst-supported trap layer lies in a value ranging from 7×10⁻⁶ to 2.9×10⁻⁴ g/m².

13. A gas sensor element comprising:
a solid electrolyte body having oxygen ion conductivity;
a measuring gas detecting electrode formed on one surface of the solid electrolyte body;
a reference gas detecting electrode formed on the other surface of the solid electrolyte body;
a diffusion resistance layer formed so as to surround the measuring gas detecting electrode and available to permeate measuring gas to the measuring gas detecting electrode; and
a catalyst layer formed on an outer side surface of the diffusion resistance layer and including a large number of aid materials and large number of catalysts which are mixed with each other;
wherein the catalysts include noble metal particles having an average particle diameter of a value ranging from 0.5 to 5 μm.

14. The gas sensor element according to claim 13, wherein:
the catalyst layer has an average film thickness of a value ranging from 5 to 50 μm.

15. The gas sensor element according to claim 13, wherein:
the catalyst layer includes the catalysts whose noble metal particles have 10 to 80 wt % gross weight with respect to a gross weight of the catalyst layer.

16. The gas sensor element according to claim 13, wherein:
the catalyst layer has a porosity of a value ranging from 15 to 50%.

17. The gas sensor element according to claim 13, wherein:
the aid materials are composed of more than one kind of material selected from the group consisting of at least alumina, zirconium and glass.

18. The gas sensor element according to claim 13, wherein:
the catalyst layer is formed by printing a paste for the catalyst layer on the outer side surface of the diffusion resistance layer with the paste being subjected to heat treatment at temperatures higher than 900° C.

19. The gas sensor element according to claim 13, wherein:
the catalysts are composed of more than one kind of material selected from the group consisting of at least Pt, Rh and Pd.

20. The gas sensor element according to claim 13, wherein:
the diffusion resistance layer comprises more than one kind of porous material selected from the group consisting of at least alumina and zirconium; and
a diffusion distance, representing a length in which a linear line, interconnecting the outer side surface of the diffusion resistance layer and the measuring gas detecting electrode, passes through the diffusion resistance layer, lies in a value greater than 0.2 mm.

21. The gas sensor element according to claim 13, wherein:
an activity time is selected to lie in a value less than five seconds.
